(19) United States
(12) Patent Application Publication
(10) Pub. No.: US 2014/0002266 A1
(43) Pub. Date: Jan. 2, 2014

(54) Methods and Apparatus for Muscle Memory Training

(71) Applicant: David Hayner, Austin, TX (US)

(72) Inventor: David Hayner, Austin, TX (US)

(21) Appl. No.: 13/931,740

(22) Filed: Jun. 28, 2013

Related U.S. Application Data
(60) Provisional application No. 61/667,100, filed on Jul. 2, 2012.

(51) Int. Cl. G08B 7/00; G06F 17/50

(52) U.S. Cl. CPC G08B 7/00; G06F 17/5009
USPC 340/573.1; 703/6

(57) ABSTRACT

Apparatus and methods for the collection, processing, storage, communication and use of data generated by an array of sensors connected to a body for the purposes of monitoring and measuring sequences of body structural motion (exercises). This training and feedback may be used to aid in the development of specific muscle memory for specific actions. Analysis of the collected data is employed to aid the user in accomplishing more efficient and effective physical training. Data may also be used by 3^{rd} parties to monitor performance and update training regimes.

### CROSS-REFERENCE TO RELATED APPLICATIONS

Provisional Application: Methods and Apparatus for Muscle Memory Training

Application Number: 61/667,100 filed Jul. 2, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field addressing applications of sensors. More specifically, this invention discloses the employment of one or more sensors, digital processing systems, storage and communications devices to aid in training specific muscle memory behaviors. An array of sensors and signal processing systems are employed to monitor the structural motions of a body performing various motions and provide feedback concerning the accuracy of these motions relative to specified structural motions.

Data collected by a network of sensors can be used to record and quantify the structural motions of an animal body performing various training drills critical to the development of the specific muscle memory behaviors required for successful performance in many athletic and non-athletic physical endeavors. Examples include the set of structural motions required to shoot a free-throw in basketball or a backhand in tennis. Many other examples also exist. Data collected by an array of sensors can be processed to generate a template representing an ideal sequence of structural motions for a specific activity for a given individual. Subsequent to the generation of the template, data collected by the array of sensors can be processed to quantify a single performance of a sequence of structural motions relative to the specified, or ideal, sequence of structural motions previously generated and represented by the template. This comparison can provide the basis for real-time feedback to the user concerning the performance of the specified sequence of structural motions. This feedback can aid in improving training or rehabilitation efficiency and effectiveness. Data concerning the user's performance over one or more repetitions can be collected for review and monitoring. This data can assist both training professionals and trainee in the design and the execution of specific skill set drills, regimes, rates and scheduling to optimize overall training or rehabilitation effectiveness. Furthermore, other desirable features and characteristics of the embodiments presented here will become apparent from the subsequent detailed description taken in conjunction with the accompanying drawings and this background.

### SUMMARY OF THE INVENTION

The present invention employs a multiplicity of sensors, microprocessors, storage media and communications systems to collect and/or measure data concerning the structural motions of animals performing various physical motions.

### BRIEF DESCRIPTION OF THE DRAWINGS

Various embodiments will hereinafter be described in conjunction with the following figures, wherein like numerals denote like elements, and

FIG. 1 is a diagram of a data processing and communications unit connected to an array of sensors which are attached an animal body structure (human arm) for the purposes of collecting data regarding the motions of this structure in accordance with one embodiment of the invention;

FIG. 2 is a diagram of an array of sensors, processors, user interface, power supply, storage and communications systems and remote controller and interface configured in a manner to collect, process, record and communicate data collected from an array of sensors attached to a structure in accordance with one embodiment of the invention;

FIG. 3 is diagram of a data processing and communications unit connected to an array of sensors attached to an animal body structure (arm) and an second data processing and communications unit connected to a second array of sensors attached to a second animal body structure (leg) for the purposes of simultaneously collecting data from both structures regarding the coordinated motions of these structures in accordance with one embodiment of the invention;

FIG. 4 is diagram containing a remote controller and interface communicating with external systems (the internet for instance) and one of two data processing and communications systems, each consisting of an array of sensors, a processor, user interface, power supply, storage and communications systems configured in a manner to simultaneously collect, process, record and communicate data generated from both sets of sensors attached to the body structures in accordance with embodiment of the invention;

FIG. 5 is a an example of data collected from an array of sensors arranged on a human body while this subject is performing twelve repetitions a specified sequence of body structural motions (an arm curl) in accordance with one embodiment of the invention;

FIG. 6 is a selected subset of the data collected by the array of sensors arranged on a human body during this subject's performance of one successful repetition of a specified sequence of body structural motions in accordance to one embodiment of the invention;

FIG. 7 is a flow diagram of the data collection and analysis processes pertaining to the collection of data employed in the generation of templates representing a measure of the body structural motions over time as collected by a sensor array arranged on an animal body in accordance with one embodiment of the invention;

FIG. 8 is a flow diagram of the data collection and analysis processes pertaining to the collection of sensor array data for the quantification of body structural motions relative to previously generated templates in accordance with one embodiment of the invention;

FIG. 9 contain flow diagrams of potential methods of employing a template transformation function used to map the measures of one individual's body structural motions into a form consistent with a given reference template in accordance with one embodiment of the invention;

FIG. 10 is a flow diagram describing the process of generating a template transformation function between a reference template and an arbitrary, approximately similar template, to enable the quantification of the body structural motions relative to the reference template in accordance with one embodiment of the invention;

FIG. 11 is a flow diagram in which reference templates are generated or modified via static physical measures of the body structure on which the sensor array will be operating and the arrangement and type of sensors placed on the body in order to support useful quantification of measured body structural motions relative to these generated of modified templates.

### DETAILED DESCRIPTION OF EMBODIMENTS

The following detailed description is merely exemplary in nature and is not intended to limit the scope or the application and uses of the described embodiments. Furthermore, there is no intention to be bound by any theory presented in the preceding background or the following detailed description.

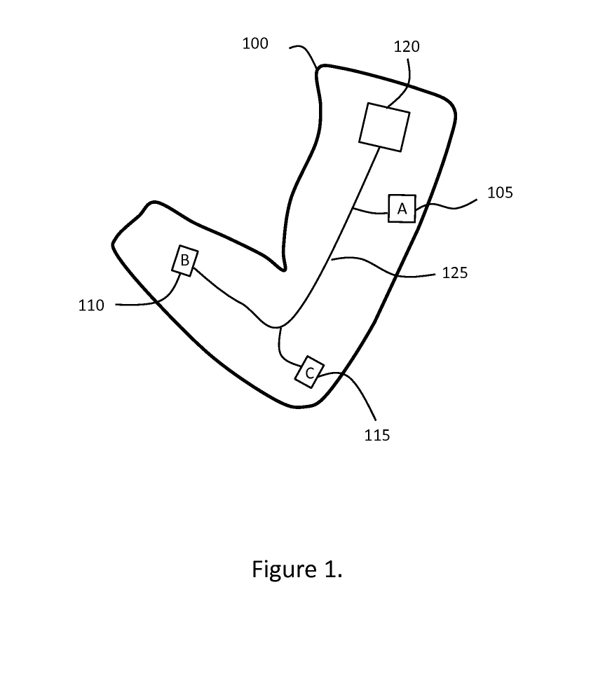

Referring now to the invention, FIG. 1 illustrates multiple sensors 105, 110 and 115 attached to a human arm 100. These sensors 105, 110 and 115 are also denoted as A, B and C respectively to aid in discussions in other figures. These sensors are connected to a Data Processing and Communications device 120 via a bussing system 125. These sensors may be attached via adhesive, straps, braces, sleeves or any other method effective for mounting sensor devices on a body in a manner in which they are substantially fixed in position relative to the body. These sensors are arranged in a manner to collect data regarding the motion of a body structure. This data is used for two primary purposes. In the first case, this data is used to generate reference templates describing successful and possibly unsuccessful versions of a specific sequence of body structural motions. An arm curl exercise, a golf swing are examples. An external observer, a trainer or coach for instance, can provide the assessments used to quantify a particular occurrence or repetition of the sequence of body structural motions as successful or unsuccessful and possibly assign a quality measure to this repetition. The action of shooting a free-throw in basketball is another example.

The second primary use of the data is score the user's performance of the proscribed sequence of body structural motions relative to the previously generated template. One repetition of the arm curl exercise or one basketball free-throw is examples of what might be scored. This scoring can then be used to measure the quality of each repetition, and count and/or grade the repetition as successful or not successful in a manner consistent with the assessment the trainer could have provided. This process can be used to aid in training the muscle memory specific to the proscribed sequence of body structural motions—shooting a free-throw for example. In a simple implementation, if a particular repetition was sufficiently close to one or more “good” templates, the system would increment a counter on the user interface and/or provide other feedback to inform the trainee that they have successfully completed acceptable repetition. If the particular repetition was not sufficiently close to one or more “good” templates or too close to one or more “bad” templates, the system could register this as an unsuccessful repetition and could provide some feedback to the trainee of this result.

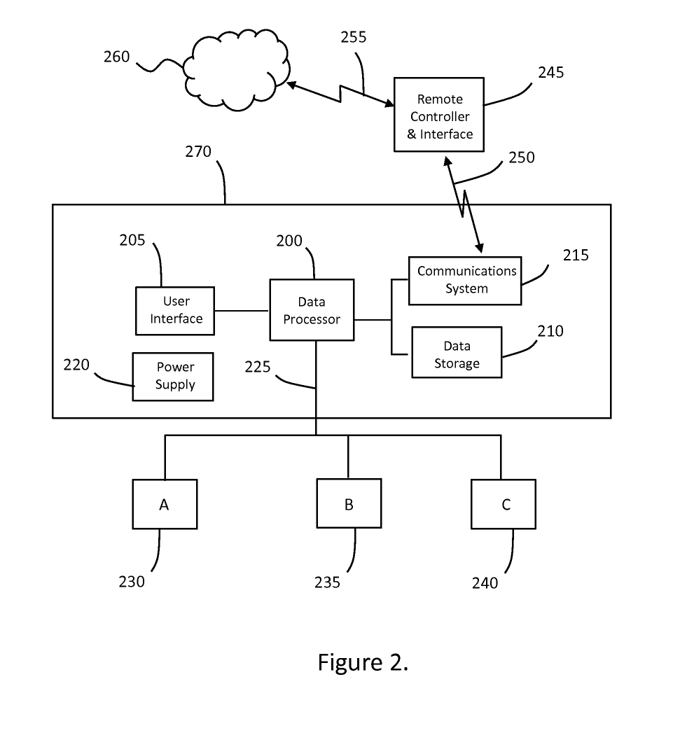

Illustrated in FIG. 2 is a Data Processing and Communications device 270 containing a Data Processor 200 connected by a communications bus 225 to three sensors 230, 235 and 240 which are represented in FIG. 1 as sensors 105, 110 and 115. Also contained in Data Processing and Communications device 270 are a User Interface 205, Communications System 215, Data Storage 210 and Power Supply 220. The three sensors 230, 235 and 240 may be physically arranged on a body structure as illustrated in FIG. 1, or in any of a number of alternate physical arrangements or alternate body structures. These sensors measure information regarding the motions of the body structure to which they are attached. This measurement data is collected at some sampling rate by the Data Processor 200. In response to software running on the Data Processor 200, the sensor data is processed for either the generation of templates and/or to quantify performance of particular sequence of body structural motions in relation to previously built templates. Results can be communicated to the trainee and/or trainer via the User Interface 205 and/or via the Communications System 215 to a Remote Controller & Interface 245. Communications between the communications system 215 and Remote Controller and Interface 245 may be wireless and/or wireline. Additionally, information regarding the performance can be recorded in Data Storage system 210 for later retrieval and study.

Communications 250 between the Remote Controller and Interface 245 and Data Processing and Communications device 270 provide several services. These include communication of templates, sensor data, configuration settings, data processing results and other miscellaneous data from the Data Processing and Communications device 270 to the Remote Controller and Interface 245. Additionally, software updates, other sensor data, configuration commands, templates, and data input into the Remote Controller and Interface 245 can be transferred to the Data Processing and Communications device 270 via this channel. Coaching inputs or grading of exercise repetitions are examples of this data.

Multiple templates representing successful and possibly unsuccessful performances of specific sequences of body structural motions may be stored in non-volatile memory which may be a subset of data storage 210. For example, there may be templates for body structural motions such as arm curls, overhead presses, leg extensions, squats, etc. stored in this memory. In addition to storing templates representing successful repetitions, templates may also be stored representing unsuccessful as well as various other grades of quality or partial success.

The sensors 230, 235 and 240 may be any combination of gyroscopes, linear or angular accelerometers, position encoders, magnetometers, tachometers, strain gauges, pressure sensors, optical or radio frequency measuring systems employed for measuring the movement of the body structure to which these sensors are attached. While these paragraphs have referred to three sensors, any number of sensors, in virtually any structural combination, could be employed in this system without substantially deviating from the methods taught in this patent.

Communications bus 225 and Communications System 215 may be any of a number of wireline or wireless systems currently available or may become available in the future. The specifics of the Communications System are substantially independent of the methods taught in this patent.

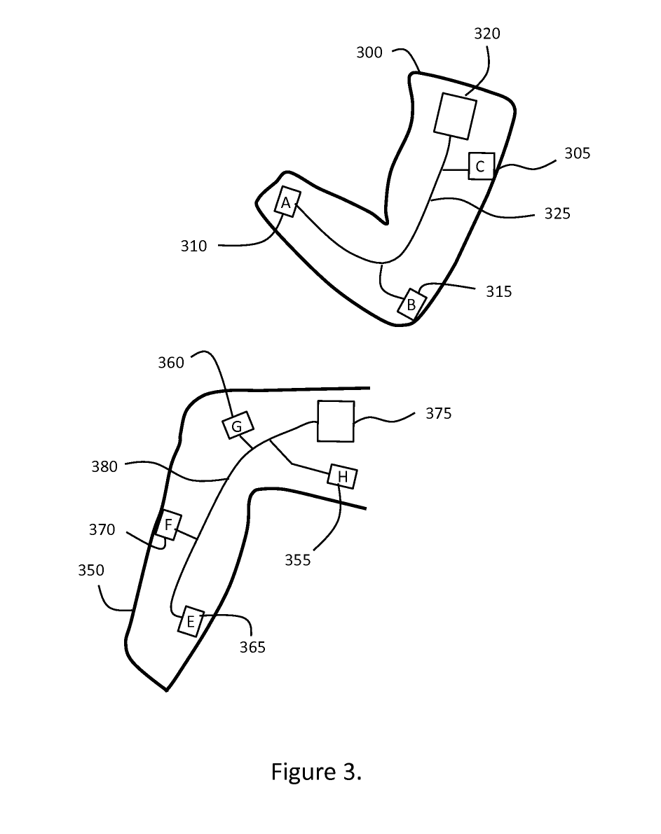

In FIG. 3 are illustrated two body structures, each with a Data Processing and Communications device 320 or 375 connected to an array of sensors. At the top of this figure, an arm 300 is instrumented with three sensors 305, 310 and 315 connected via Communications Bus 325 to Data Processing and Communications device 320. At the bottom of this figure, a leg 350 is instrumented with four sensors 355, 360, 365 and 370 connected via Communications Bus 380 to Data Processing and Communications device 375. Data Processing and Communications device 375 can communicate and exchange data with Data Processing and Communications device 320 via the communications system contained in each of these units.

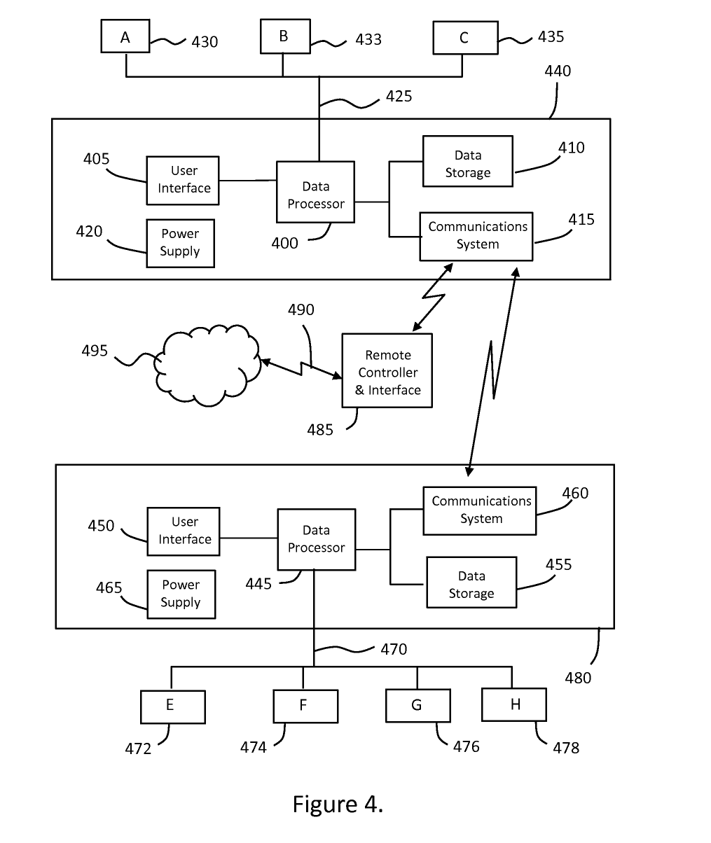

This communication between sensor arrays located on separate body structures is illustrated in more detail in FIG. 4. At the top of this of FIG. 4 is a Data Processing and Communications device 440 containing Data Processor 400, User Interface 405, Data Storage 410, Communications System 415 and Power Supply 420 and correspond to the Data Processing and Communications device 320 on the arm 300 in FIG. 3. In FIG. 4, Data Processor 400 is connected to sensors 430, 433 and 435 via Communications Bus 425. By use of Communications System 415 in Data Processing and Communications device 440 and via Communications System 460 contained in Data Processing and Communications device 480, information can be exchanged between these two Data Processing and Communication devices.

Data Processing and Communications device 480 also contains a Data Processor 445, Data Storage 455, User Interface 450, Power Supply 465, and Communications System 460 and is connected to sensors 472, 474, 476 and 478 via communications bus 470. As a result of the communications between Data Processing and Communications device 440 and Data Processing and Communications device 480 either Data Processor 400 or Data Processor 445 may have access to all the data generated by the sensor arrays. This capability enables the consistent collection and processing of data generated the sensor array on the arm together with data generated by the sensor array on the leg. These two systems may be on the same body or separate bodies. More generally, these sensor arrays can be located on other body structures, back, hand, or foot for example. A representative system may include three systems of sensor arrays and Data Processing and Communications devices, one located on the left arm, a second on the right arm and a third on the torso.

Communications between Data Processing and Communications device 440 via Communications System 415 and the Remote Controller and Interface 485 can serve several purposes. As previously discussed, coaches can use the Remote Controller and Interface 485 to input external assessments of an exercise. The Remote Controller and Interface 485 can also provide means to configure the two Data Processing and Communications devices 440, 480; download programs, templates, updated counts for successful completions of body structural motions, upload data and/or results, exchange generated templates, system status and configuration data. In many cases, the Remote Controller and Interface 485 will communicate with one of the Data Processing and Communication devices, 440 or 480 which is established as the master. The Remote Controller and Interface 485 could also be configured to communicate directly with one or more Data Processing and Communications devices 440, 480.

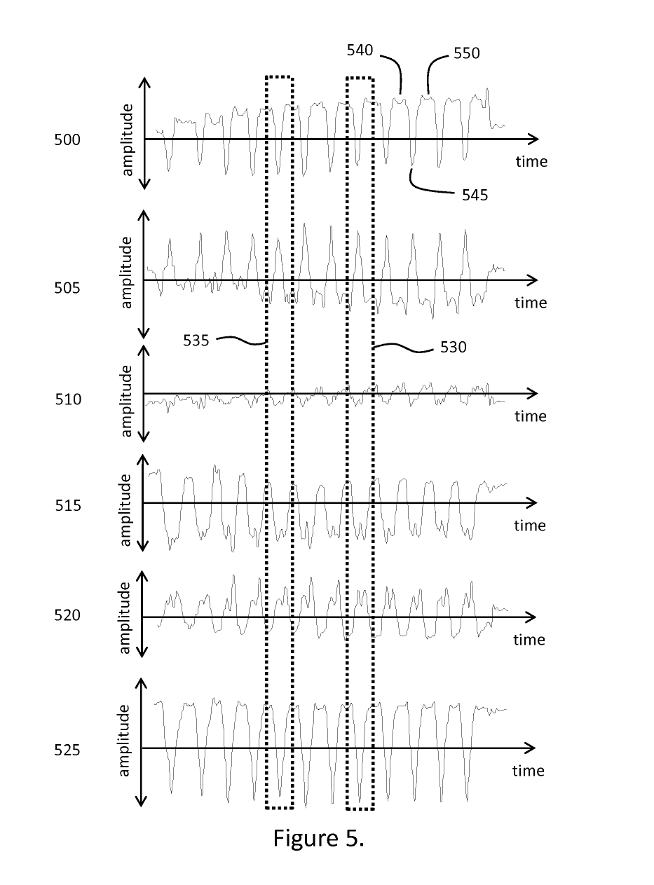

Illustrated in FIG. 5 is a sample set of data collected from a human body performing twelve repetitions of a specified sequence of body structural motions with two, 3-axis accelerometers attached to the body at specific locations. Data sets 500, 505 and 510 are respectively the x, y and z-axis data from the first accelerometer. Data sets 515, 520 and 525 are respectively the x, y and z-axis data from the second accelerometer. For this particular sequence of motions, body structure, arrangement of sensors and type of sensors, a repetition is represented by the data starting at a plateau 540 in data set 500, transitioning through a spike 545 and then returning to the next plateau 550. The first five repetitions, ending with repetition 535, were graded as unsuccessful by a coach. The last seven repetitions were graded as successful by the coach. A representative successful repetition is the data denoted by 530.

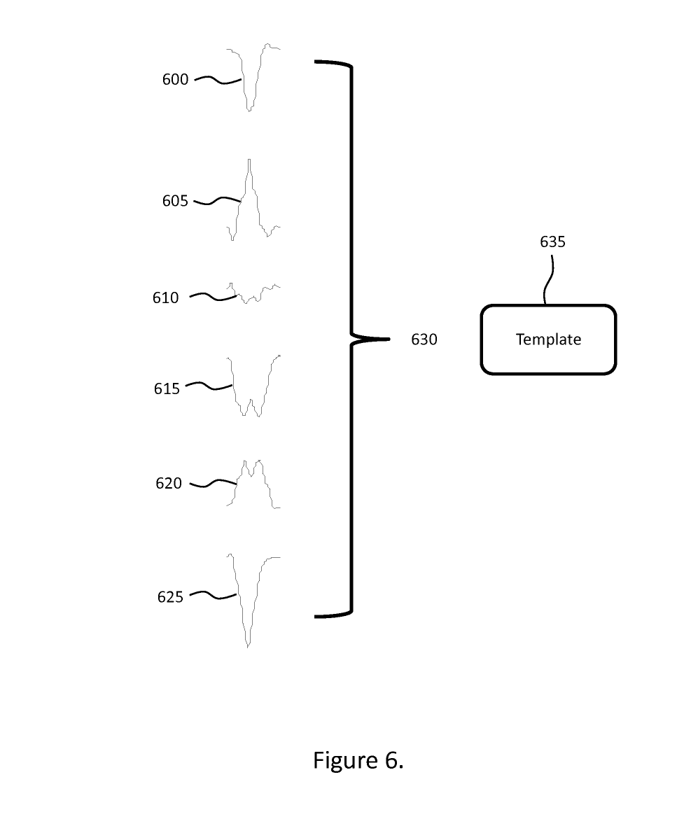

In FIG. 6, a representative successful repetition is extracted as a set of six short term (in time) data sets 600, 605, 610, 615, 620 and 625. Each of these data sets, 600-625 is a channel of data. This data set 630 represents one possible form of a template 635. A template may be formed from one or more channels of data from one repetition of a sequence of body structural motions; it may formed via the combination of different channels of data across several repetitions; it may be formed via some computational averaging or estimation of a best fit data sequence for one or more channels and then one or more of these artificial data sets combined to create a template. Alternately, various system identification, modeling or transform methods (Fourier Transforms for example) may be applied to this data to generate alternate mathematical or analytical versions of data from which templates are derived. Various permutations and combinations of the above methods are also viable methods for generating templates. Various automated methods for generating, selecting or constructing a reference template can be designed.

Additionally, various features may be extracted from the data sets 600-625 and these features used, possibly in conjunction with the original amplitude vs. time data, to generate template and to be measured against templates. Examples of these various features include filtered version of this data, linear or non-linear combinations of data or extracted features, etc.

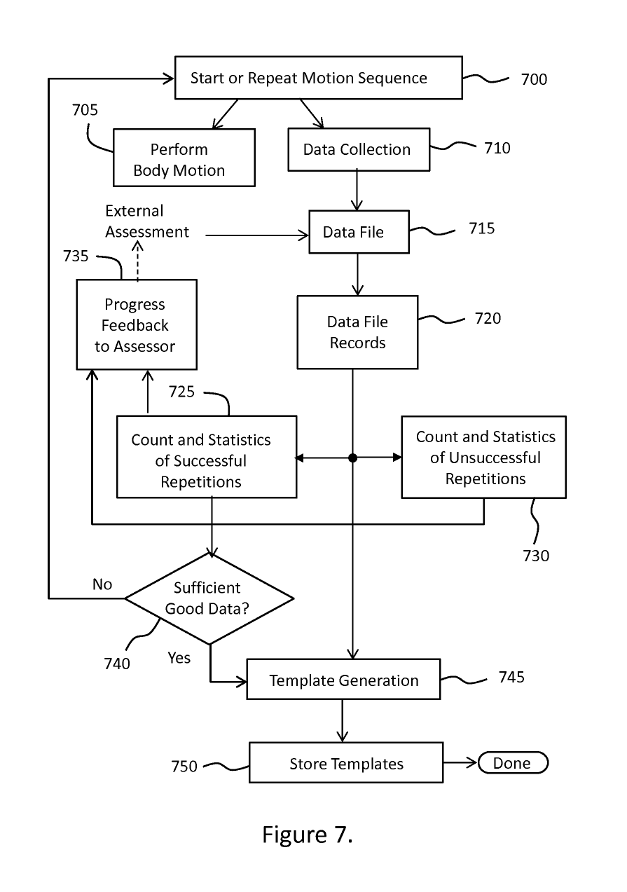

In FIG. 7, is illustrated a diagram for one possible method for collecting data sets that can be employed for building a set of templates for a given sequence of structural body motions performed by a user. The user starts a series of repetitions of a specific sequence of body structural motions; block Start or Repeat Motion Sequence 700. During each repetition of this motion sequence, denoted as block Perform Body Motion 705, Data Collection function 710 acquires data from the array of sensors. As an example, sensors 230, 235 and 240 of FIG. 2 can perform this function. The resulting Data File 715 is augmented with an External Assessment of the quality of this repetition. This External Assessment may be a quality score a coach or trainer has made concerning the just complete repetition of the specified sequence of body structural motions.

These data logging and collection operations are performed by the Data Processor 200 of FIG. 2. The External Assessor's score may be entered into the Remote Controller and Interface 245 of FIG. 2 and relayed to the Data Processor 200 in FIG. 2. All of the data files representing successful or unsuccessful repetitions are stored in Data File Records 720. As this data is collected, statistics on each data file representing a repetition can be calculated 725, 730 to provide Progress Feedback to Assessor 735 to aid in coaching the user in the next repetition. Some of the statistical measures of the successful repetitions may be employed to determine when a sufficient number of successful and/or unsuccessful repetitions have been performed, Sufficient Good Data 740, to allow the generation of templates in Template Generation 745. This decision may also be made by the assessor. Templates may be generated for successful, unsuccessful and possibly other quality grades of a repetition of the specified sequence of body structural motions. These templates are then stored for later use 750.

Template generation and associated calculations can be performed on the Data Processor 200 of FIG. 2. Alternately the Data File Records 720, or some subset of this data file can be relayed to the Remote Controller and Interface 245 of FIG. 2 and some or all of the calculations required for Template generation can be executed on this platform. In the second case, it may not be necessary to relay the performance assessment to the processor 200 of FIG. 2. In yet another version, the Data File Records 720 can be transmitted to the Remote Controller and Interface 245 and the Data File Records 720 relayed by the Communications System 215 of FIG. 2 via wireless or wireline communications methods to other remote systems for calculation of the templates. Typically, the resultant templates will be stored in data storage 210 of FIG. 2 but could also be stored in either the Remote Controller and Interface of FIG. 2 or even remote from both devices.

The template generation process may be generalized to a wider range of assessments other than success and unsuccessful. This system may use a gradated scale, say 1 to 10, of scoring repetitions. Those repetitions with some set of scores may be processed together to generate a corresponding template for that set of scores.

In practice, the User Interface 205 or Remote Controller and Interface 245 of FIG. 2 may also include input methods allowing the coach or user to delineate the start and stop of a given repetition, the start of stop of a set of repetitions and provide other controls such as pause, restart, etc. These functions can be realized with a switch, touch screen, a voice command, an optical queue, mechanical input or some unique motion of a body of a body structure.

Multiple different sequences of body structural motions may be performed and templates generated for each and stored for future use. For example, templates could be generated for a tennis forehand shot, tennis backhand shot and tennis overhead shot. After these templates have been generated, the user can use these stored templates and repeat the motion and receive immediate feedback concerning the quality of the attempt. Repeated positive reinforcement of correct motions and possibly negative reinforcement for incorrect motions will aid in the development of the muscle memory appropriate for the given sequence of body structural motions.

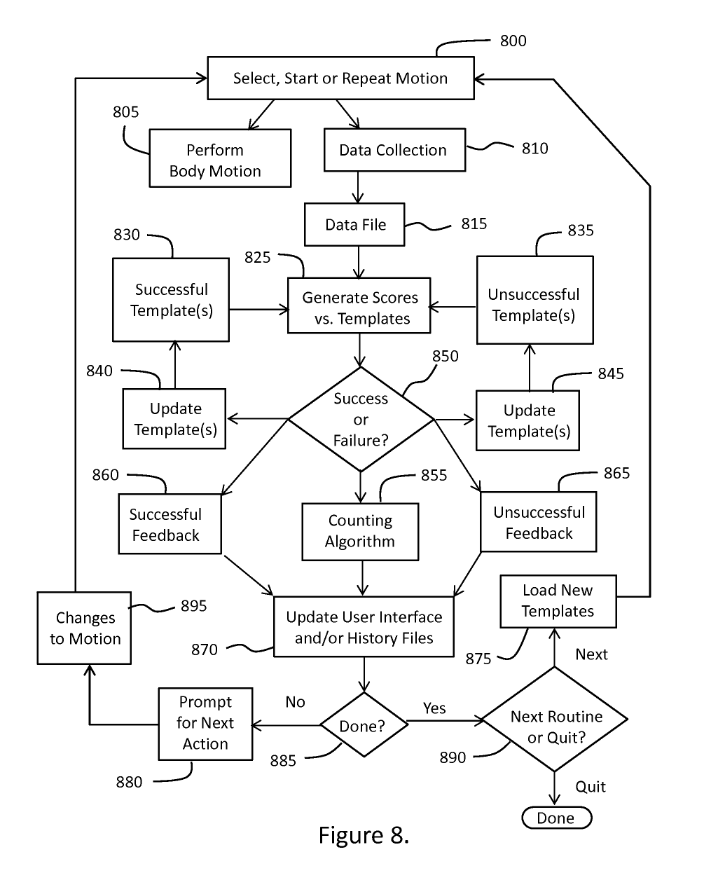

Illustrated in FIG. 8 is a flow chart representing one possible process by which a sequence of body structural motions is scored in relation to a Template and feedback provided to the user. Via the User Interface, 205 or Remote Controller and Interface 245 in FIG. 2, the coach or trainee queues up a specific sequence of body structural motions. A rehabilitation exercise for a shoulder injury is an example. Associated with this specific sequence of body structural motions are one or more stored templates representing successful and possibly other grades of success or failure of this specific sequence of body structural motions. These templates are loaded into system memory. The system may provide some combination of an audible, visual, mechanical or electrical queue to instruct the user to proceed. As the user performs each repetition of the specified sequence of body structural motions, a Data File 815 is generated concerning the body's structural motions as measured by the array of sensors 230, 235 and 240 in FIG. 2 and processed by Data Processor 200 FIG. 2. Contents of this Data File 815 are compared via the function Generate Scores vs. Templates 825 to the retrieved Successful Template(s) 830 and possibly also compared to retrieved Unsuccessful Template(s) 835.

This comparison generates a score representative of the quality of the match between the just completed repetition of a sequence of body structural motions and the stored templates. These scores are next processed to assign a successful, unsuccessful or other final score to each repetition of the specified sequence of body structural motions in the Success or Failure function 850 as they occur. The output of Success or Failure function 850 is also used to drive a Counting Algorithm 855 which is keeping track of success, failure and/or quality of the overall set of repetitions and the functional blocks Successful Feedback 860 and Unsuccessful Feedback 865. The output of the Counting Algorithm 855 is directed to the Update User Interface and/or History Files function, block 870. This functional block, together with specific feedback instructions generated in Successful and Unsuccessful Feedback blocks 860 and 865 may direct the User Interface 205 of FIG. 2 to provide various feedback responses to the user. Additionally, this feedback information, data regarding the performance of the specified sequence of body structural motions and other pertinent data may be transmitted via the Communications System 215 to the Remote Controller and Interface device 245 (FIG. 2) for alternate feedback or displays to the user and/or the coach. This feedback may be some combination of audible, visual, graphical, and mechanical concerning the quality or success/failure as each repetition as it is performed.

A decision on completion of a sufficient number/quality of the specified sequence of body structural motions, functional block Done 885 is performed on the output of the Counting Algorithm 855. Depending on the result of this operation, a Prompt for Next Action 880 can instruct the user to perform the next repetition, with optionally potential Changes to the Motion 895. Alternately, the functional block Next Routine or Quit 890 executes and either concludes this process or can select a subsequent sequence of body structural motions and cause the Load New Templates function 875 to execute which initiates the next series of repetitions of this subsequent sequence of body structural motions. These various actions are communicated to the user via the User Interface 205 of the Data Processing and Communication device 270 and/or via the Communications System 215 to the Remote Controller and Interface 245 (FIG. 2).

A variation to the above approach is also illustrated in FIG. 8 in which training repetitions are used to continuously update the various templates. In this modified approach, the results of determining if a repetition was successful or unsuccessful, Success or Failure block 850 also initiates processes 840 and 845 to possibly update the stored templates. This may be augmented with external assessments (not shown in FIG. 8). In practice, possibly only those repetitions with high “good” scores are used to update the templates representing successful repetitions and only those repetitions with particularly “bad” scores are used to update the templates representing unsuccessful or failed attempts. It may also be desirable in some cases, to use the results of performance on one specific sequence of body structural motions to influence the templates in alternate sequences of body structural motions. For instance, as a user's tennis forehand speed and range of motion increases, it may be desirable to incorporate some of these features into the templates representing tennis backhands. There are many other similar relationships that can be implemented into this system.

In some implementations, the system could provide pacing information from one repetition to the next, possibly based on the performance of previous repetitions or performance on body structural motions. In other implementations, the system could provide feedback regarding the rate of individual movements in a specific repetition; provide feedback regarding specific changes required to be successful (more/less pronation, for example) and provide other feedback to aid the user in the correct execution of the repetition. This data and could be generated during the execution of an individual repetition and provide nearly instantaneous feedback to the user and/or, provide retrospective feedback and guidance for use in subsequent repetitions.

Results generated by the user in the performance a specific repetition may be used to count successful repetitions of this specific sequence of body structural motions and no information is stored in the system from one use to the next (with the exception of the stored and possibly updated, templates). Alternately, results from one training session to the next may be recorded and used in multiple ways. One such method would be to update the number of repetitions, the range of motion, the rate or pace of each repetition, the rest period between repetitions or how often specific sequences of body structural motions are performed on a daily basis. Another method would be to advance the user through different training routines as a function of recorded results, time of day, day of the month, etc. For instance, as a user's precision in motion increases, the system could observe these results from the recorded data and select alternate templates requiring the user to increase pace and/or alter the range of motion (increase the backswing in the tennis example) required to record a successful repetition. Additionally, information on the success and unsuccessful performance on one specific sequence of body structural motions may be employed to modify an alternate, but possibly related sequence of body structural motions. Recorded data could also be used to alter the ordering of training or the specific sequences of body structural motions practiced from one session to the next.

An additional use would be to forward recorded results, and possibly raw measured data to trainers, coaches or other 3^{rd} parties to review and monitor progress and update training routines, programs, etc. In the same way, the system could also provide alerts to 3^{rd} parties regarding incorrect use or potentially less than desirable situations and other information useful for management of effective training.

In some applications, it may be desirable to generate a transform between the data measured from one user's version of sequence of body structural motions to a reference template. This reference template may be the template representing a near ideal golf swing of a specific professional golfer. A coach or user may have selected this specific professional golfer as a reference for the swing they would like the user to emulate. In this case what is desired is a method to transform a specific user's golf swing (or template) to the selected professional golfer's version of this swing and then use this as a template, even though there may be substantial differences in the templates. For instance, the club head speed a professional golfer can generate may well be far in excess of the amateur's capability, but the body mechanics of the selected professional golfer may be a good match to the specific user due to similarities in body build.

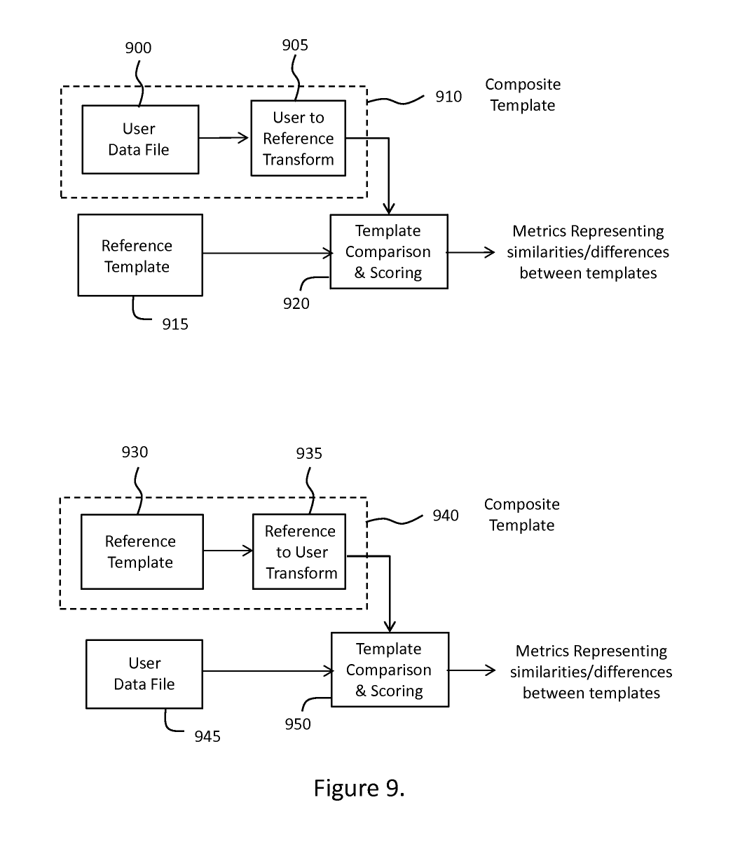

Illustrated in FIG. 9 are two possible methods this transform can be employed. In FIG. 9 (top), the user's data file 900 (or possibly template) is transformed 905 to be consistent with the Reference Template 915 so that they can be more effectively compared to each other in Template Comparison and Scoring 920. This can also be viewed as a composite user template 910 that is compared in block 920 to the Reference Template 915.

If a transform can be generated to map the user's template to the reference template, then a transform can be generated to map the reference template to the user's template. Two potential uses of this method are illustrated in FIG. 9 (bottom). In the first case, the stored Reference Template 930 is transformed via the Reference to User Transform 935 and User Data File (or template) 945 is compared via Template Comparison and Scoring function 950 to this transformed Reference Template. In an alternative use, the Reference Template is transformed once and the resulting new Composite Template 940 and is stored for future use. The original Reference Template 930 can now be discarded. This may be useful for protecting the security of the Reference Template in certain business transactions.

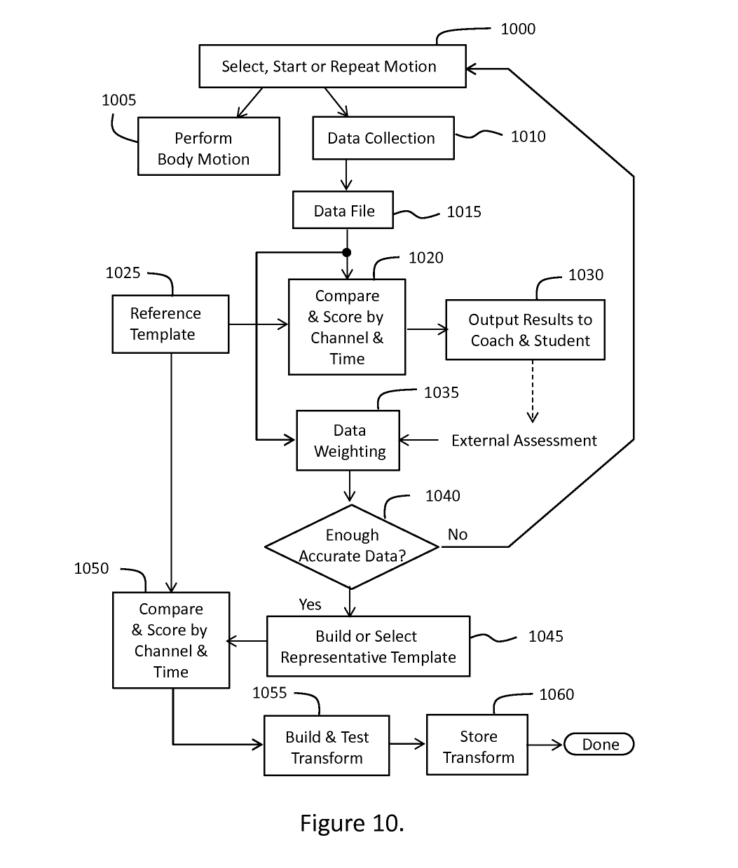

Illustrated in FIG. 10 is a process by which either the User to Reference or Reference to User template transform can be built. A Reference Template is selected and loaded (not explicitly shown). For each performance of the body motion 1005, data is collected 1010 and a Data File 1015 is generated. This Data File 1015 is compared and scored relative to the selected and loaded Reference Template 1025. Various measures of comparison are output to the coach and/or user 1030 and an external assessment is generated and entered. This assessment may address one complete repetition of the body motion, and/or address various segments of this repetition. A segment may be a specific time interval, one or more sensor outputs, one or more sequences of motion or combinations of these. The assessment is employed to weight the repetition and/or segments of this repetition 1035. When a sufficient number of accurate data files are collected, based on decision function Enough Accurate Data 1040, a representative user template is generated 1045 or additional repetitions are performed. If enough accurate data has been collected, a Template is selected or generated 1045. This is then compared 1050 to the Reference Template 1025 and a mapping is generated that transforms one to the other (either Reference to User or User to Reference). An example of this mapping is the time shifting outputs generated by a dynamic time warping (DTW) algorithm. These time shift values can be used to map the Reference Template to the User Template or the User Template to the Reference Template. Once this transform is determined, it can be tested 1055 and if of sufficient quality and/or fidelity, stored for future use 1060.

The composite template 940 of FIG. 9 can also be used as a Successful Template 830 in FIG. 8 as part of the matching process. Clearly, templates generated in this way (FIG. 9) can also be used as Unsuccessful Templates 835 of FIG. 8 depending on the specifics of the application. Alternately, the template transform and related process, as defined in FIG. 9 could be used to modify the Data File 815 prior to the Generation of Scores vs. Templates 825 in FIG. 8. These two generalizations of the template matching process as illustrated in FIG. 8 provide alternate flexibility in the use of these concepts.

There are multiple other means to generate this transform that will become evident to those skilled in these arts. The reference to dynamic time warping is only intended as an aid in teaching these ideas.

In many practical cases, it may be desirable to provide a means to calibrate or tune a generic body structural motion, say a forearm curl, push-up, etc., to a specific individual without the use of a coach or trainer providing feedback. Specific sequences of body structural motions (a push-up for example) can me modeled as a set of time varying forces, muscle actions, applied to various body structural elements, bones and joints, in a specific sequence. This can be analytically modeled as a combination of beams, joints, dampers and springs driven at various locations by specific forces. For example several arm exercises involve motions around the elbow and/or shoulder joint preceded and/or followed by supination/pronation and/or wrist motions. This sequence of forces can be specified and/or recovered from data files representing successful sequences of body structural motion examples performed by a user. A model of the underlying physical structure can also be derived via system identification techniques for example, from these data files. Alternately, many accurate models, together with the requisite time varying forces are available in the literature for a wide variety of biomechanical structures performing various actions or exercises.

Application of the time varying forces to a model of the appropriate physical body structure will generate the appropriate time sequence of structural motions, e.g., a model of the specific sequence body structural motion. A repetition of a tennis forehand for example. By inclusion into this model of the appropriate sensor types and their locations, this model can generate a close approximation to the data collected on a body augmented with the same types of sensors in substantially similar locations. Parameterization of this model to a specific individual's structural characteristics will enable the generation of functionally useful user specific templates.

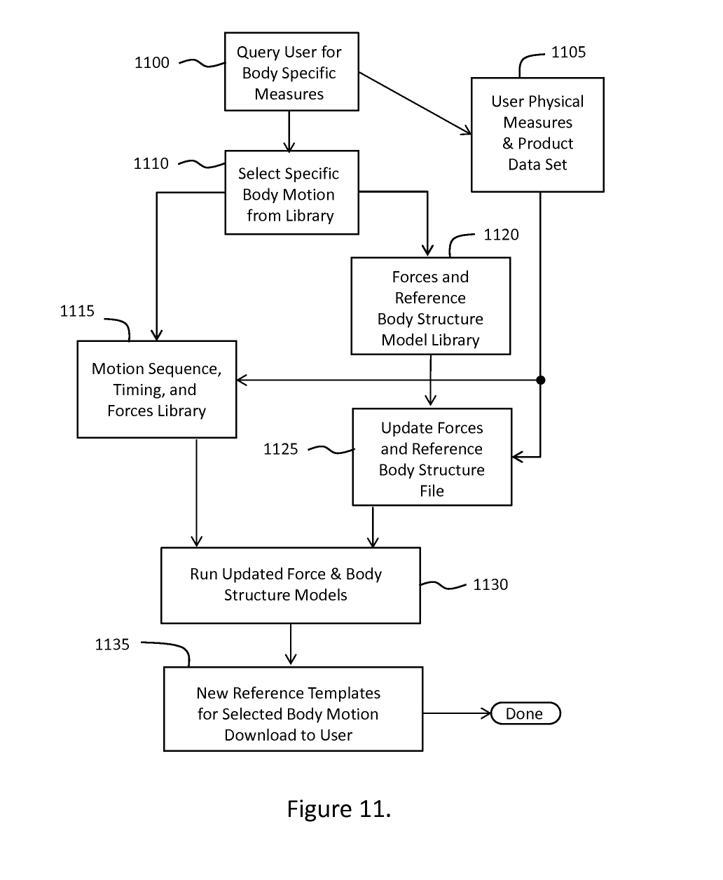

Illustrated in FIG. 11 is a data flow diagram of this process. To start, the system queries the user for Body Specific Measures 1100 unique to the individual. These measures may include height, weight, fingertip-to-fingertip distance, elbow to wrist distance, etc. This data, together with specifics features of the product employed (types, number and location of sensors), forms the User Physical Measures and Product Data Set 1105. Next, the user selects a specific sequence of body structural motions from a library 1110. Associated with each of these sequences of body structural motions are Forces and Reference Body Structure Model Library 1120 and a Motion Sequence, Timing and Forces Library 1115. These can be built from information generally available in the relevant published literature. For instance, a model in this library may represent a human shoulder joint, upper arm, elbow joint and forearm. Parameters in this model represent the various lengths between joints and forces generated. Models in the Motion Sequence Timing and Forces Library capture the time sequence of forces than must be applied, and by what muscles, in the appropriate order, to perform a specific sequence of body structural motions.

Based on the User Physical Measures 1105, the models described in the Forces and Reference Body Structure Model Library 1120 are appropriately modified for the specific individual. Also, sensor types and positions are inserted into the model based on user, and possibly product specific characteristics 1125. This model, modified to the specific user and product, is then driven by data from the Motion Sequence, Timing and Forces file which is specific to the specific sequence of body structural motions selected, and possibly modified by the user specific data. This activity is captured by the Run Updated Force and Body Structure Models block, 1130. Output of block 1130 is substantially the same as the data that would have been collected on the specific user, performing the specified sequence of body structural motions with the selected product. These data files can then be employed to generate a template for this user as previously described. See discussion associated with FIG. 7. This template can then be transferred to the user for future use in the selected product without the assistance of a 3^{rd} party to generate external assessments.

Processing elements contained in Data Processor 200 of FIG. 2 may be any integrated circuit device configured for a particular purpose. As such, the Data Processor 200 in FIG. 2 may be any application specific integrated circuit (ASIC), microprocessor, or other logic device known in the art or developed in the future. Data Storage 210 in FIG. 2 may be any form or combination of volatile and non-volatile memory. This may be dedicated hardware of the system or fully or partially contained in other elements in the Data Processing and Communications device 270 of FIG. 2. This memory may be of any available storage media currently known in the art or developed in the future. Communications System 215 of FIG. 2 may be a combination of wireless and wireline methods currently known in the art or developed in the future. Communications bus 215 of FIG. 2 is inferred to be wireline based, can be of any presently known form or one that may be developed in the future. There is no requirement that the sensor-to-sensor or sensor-to-data processor communications be wireline based. This communication can be wireless based without substantially impacting the methods taught in this patent disclosure.

The User Interface 205 of FIG. 2 may be any combination of audio, visual, mechanical, electrical, touch or other human sensory input and output mechanism. The Remote Controller and Interface 245 may be virtually any programmable device which can communicate wireless and/or wireline with Data Processing and Communications device 270. For instance, Remote Controller and Interface 245 may be a personal computer, computing tablet, smartphone or any of a number of other similar devices. The user interface on this Remote Controller and Interface 245 can be customized to interact with Data Processing and Communications device 270 to accomplish the various functions described in the previous sections. For instance, a smartphone may be programmed with an application enabling it to navigate menus contained in Data Processing and Communication device 270, download and upload data or templates via the communications interface 215, modify user settings and perform many other operational functions in conjunction with Data Processing and Communications device 270. Additionally, the Remote Controller and Interface 245 may serve as the primary interface a coach or 3^{rd} party may use to input external assessments (grade a repetition). These scores can be communicated to Data Processing and Communication device 270 via the Communications System 215.

Several references have been made to techniques associated with pattern recognition technologies and methods. Those skilled in the art of pattern recognition will recognize multiple methods in which the training, measuring and scoring processes can be implemented. References to specific techniques are substantially inconsequential since the specifics of these methods are substantially independent of the uses taught in this patent application.

The previous discussion is not intended to limit the specific numbers, types and physical or logical arrangements of sensors, specific data rates, bussing or communications systems. References to specific techniques are used only as a means to explain an example of the art. Those skilled in these methods are aware of many alternate methods that can be employed.

In summary, systems, devices, and methods configured in accordance with exemplary embodiments relate to:

A data processing and communication device comprising data processing elements, an array of one or more sensors coupled to the data processing elements and configured to provide measures of the structural motions of the body structure to which the sensors are mounted, data storage systems, means for providing various types of mechanical, electrical, audible or visual feedback to the user, communications systems enabling this device to communicate with 3^{rd} party data processing platforms, a user interface enabling user control of the data processing and communications device.

This data processing and communications device is intended to collect data regarding the sequence of structural motions of body structures performing a proscribed sequence of body structural motions. The sensors are attached to a body in some manner which substantially maintains the sensors in a fixed physical relationship to the body and to each other. The collected data is primarily used to either generate reference templates describing a sequence of body structural motions, or to be used in the measurement and scoring of these body structure motions relative to the previously generated templates. In certain embodiments, the sensors may be one or more of an angular or linear accelerometer, gyroscope, tachometer, angular resolver, pressure, acoustic, temperature, magnetic, optical, torsion, tension or force measuring devices.

The data processing and communications device as described above in which collected data, together with external assessments, are used to generate templates which represent one or more grades of performance of a particular sequence of body structural motions. These external assessments can be made by 3^{rd} parties observing repetitions of the specified sequence of body structural motions.

The data processing and communications device as described above in which collected data are compared in some manner to previously generated templates to measure or score the performance of a specific repetition of a specified sequence of body structural motions.

The data processing and communications device as described above in which results of a scored repetition of the specified sequence of body structural motions are provided to the user and/or coach in some manner. This feedback may be visual, audio, mechanical or electrical.

The data processing and communications device as described above in which results of a scored repetition of the specified sequence of body structural motions are provided to the user in some manner during the execution of a specific repetition in order to guide the performance of this repetition. This feedback may be visual, audio, mechanical or electrical.

The data processing and communications device as described above in which results of the scored repetitions of the sequence of body structural motions are employed to modify this specific sequence of body structural motions, select an alternate sequence of body structural motions, alter pace, quantity, form, weight or other relevant elements of a repetition.

The data processing and communications device as described above in which collected data, repetition results, statistics or other measures are stored and/or communicated to 3^{rd} parties. This communication may be immediate or delayed. These communications may enable allow 3^{rd} parties to monitor performance in real-time to provide immediate feedback on performance or to enable changes in parameters defining a specific sequence of body structural motions.

The data processing and communications device, the first system, as described above in which a remote device, the second system, can emulate the user interface contained in the first system, configure parameters of said first system and manage said first system. Said remote device is substantially the same as the Remote Controller and Interface, 245 in FIG. 2.

The data processing and communications device, the first system, as described above in which a remote device can download and upload data, templates, template transforms, software updates to or from said first system.

The data processing and communications device, the first system, as described above in which a remote device can provide a mechanism for 3^{rd} parties to review performance activities and input external assessments.

The data processing and communications device as described above in which a remote device provides a graphical display of a user performing a specific sequence of body structural motions and highlights in various ways correct and incorrect actions which lead to a successful or unsuccessful repetition.

The data processing and communications device as described above in which new data collected during the repetition of a sequence of body structural motions routine can be employed to update existing templates. The processing required can be performed in said first system and said second system.

The data processing and communications device as described above in which collected data is employed to build a transform between a user and reference template. The processing required can be performed in said first system and said second system.

The data processing and communications device as described above in which user to reference template transforms are employed to aid in training The processing required can be performed in said first system and said second system.

Methods to build reference templates for various specific sequences of body structural motions based on models of the animal body, parameters specific to a unique animal body, the specific arrangement and types of sensors employed and the specific motion sequence to be performed.

The data processing and communications device, the first system as described above in which multiple of these first systems inter-communicate and one of said first systems is the master. Data processing associated with the functions of said first systems may be distributed among the data processors contained in said first systems, centralized in one and shared with said second system. Similarly, generation of templates, generation and use of template transformations may also be distributed among said data processors, centralized in said first system and shared with said second system.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention.

1. A data processing and communications device comprising:
data processing devices;
an array of a plurality of sensors coupled to the data processor and configured to generate an output measuring the sequence of structural motions of the body structure to which the sensors are mounted;
data storage consisting of volatile and non-volatile memory systems coupled to the data processing devices;
communications systems coupled to the data processing device enabling this device to communicate with 3^{rd} party data processing platforms;
data processing methods enabling the capability to build reference templates based on data generated by a user performing several repetitions of a specified set of body structural motions as measured by said array of a plurality of sensors and data representing external assessments grading each of these several repetitions of the specified set of body structural motions;
a means of providing audio, visual, mechanical or electrical stimulation to the user in response to some measure of the similarity between a repetition of a specific set of body structural motions as measured by said array of a plurality of sensors and a selected template representing a set of body structural motions;
a user interface providing the ability for the user to manage said data processing and communications device; and
a means of recording and analyzing date generated by said array of a plurality of sensors measuring specific sets of body structural motions and forwarding this data to a 3^{rd} party data processing platform via various communication interfaces.

2. The data processing and communications device of claim 1, augmented with data processing methods enabling the capability to modify templates as a result of the user's performance on a plurality of repetitions of specific set of body structural motions.

3. The data processing and communications device of claim 1, augmented with data processing methods enabling the capability to alter the ordering, pace, repetitions and required quality of the performance of specific set of body structural motions in response to the user's performance on a plurality of repetitions various sets of body structural motions.

4. The data processing and communications device of claim 1, augmented with data processing methods enabling the generation of comparison metrics between data generated by a specific set of body structural motions as measured with said data processing and communications device to a plurality of templates representing a set of body structural motions and providing feedback to the user and 3^{rd} parties based on these comparison metrics.

5. The data processing and communications device of claim 1, augmented with data processing methods enabling the capability to build transformation functions between reference templates and user templates.

6. The data processing and communications device of claim 1, augmented with a 3^{rd} party data processing platform and appropriate software in the 3^{rd} party data processing platform that can manage said data processing and communications device; transfer data, templates or programs between said data processing and communications device and 3^{rd} party data processing platform and display data and results from said data processing and communications device and provide audio, visual, electrical and mechanical feedback to the user or coach.

7. The data processing and communications device of claim 1, augmented with a 3^{rd} party data processing platform and appropriate software in the 3^{rd} party data processing platform enabling the ability to send and receive data between said data processing and communications device and said 3^{rd} party data processing platform and build reference templates based on data generated by a user performing several repetitions of a specified set of body structural motions as measured by said data processing and communications device and data representing external assessments of these several repetitions of the specified set of body structural motions.

8. The data processing and communications device of claim 1, augmented with a 3^{rd} party data processing platform and appropriate software in the 3^{rd} party data processing platform enabling the ability to send and receive data between said data processing and communications device and said 3^{rd} party data processing platform and the capability to generate comparison metrics between data generated by a specific set of body structural motions as measured with said data processing and communications device to a plurality of templates representing a set of body structural motions and providing feedback to the user and 3^{rd} party platform users based on these comparison metrics.

9. Software systems for building reference templates comprising of:
methods to acquire from a user specific body dimensions and characteristics;
methods to incorporate product specific parameters concerning the physical characteristics, sensor types and numbers, locations and other pertinent information associated with the collection of body structural motion information;
methods to modify models of body structures with user and product specific information to synthesize the specific alignment of an array of one or more sensors on a user for a specific sequence of body structural motions;
methods to run these models, collect synthesized data substantially similar to data that would be collected on a user with a specific alignment of array of one or more sensors arranged on a user while the user is performing the specified body structural motions and generate reference templates from this synthesized data.
